(19) United States
(12) Patent Application Publication
(10) Pub. No.: US 2026/0033932 A1
(43) Pub. Date: Feb. 5, 2026

(54) LIQUID STORAGE ASSEMBLY AND ORAL CLEANER

(71) Applicant: Shenzhen Soocas Technology Co., Ltd., Shenzhen (CN)

(72) Inventors: Wenxu GAN, Shenzhen (CN); Yuanping ZHANG, Shenzhen (CN); Zhoujian LI, Shenzhen (CN)

(73) Assignee: Shenzhen Soocas Technology Co., Ltd., Shenzhen (CN)

(21) Appl. No.: 18/981,795

(22) Filed: Dec. 16, 2024

Related U.S. Application Data
(63) Continuation of application No. PCT/CN2024/128305, filed on Oct. 29, 2024.

(30) Foreign Application Priority Data
Aug. 5, 2024 (CN) 202411075506.9

(51) Int. Cl. A61C 17/22; A61C 17/02

(52) U.S. Cl. CPC A61C 17/227; A61C 17/0202

(57) ABSTRACT

The present disclosure discloses a liquid storage assembly and an oral cleaner. The liquid storage assembly includes: a casing having a first shell wall, where the first shell wall is provided with a communicating pore penetrating through the first shell wall along a first direction, and at least a portion of an inner surface of the first shell wall is configured to limit a liquid storage cavity; and a limiting member positioned on an inner side of the first shell wall and configured to limit a ventilation flow channel. The ventilation flow channel is communicated with the liquid storage cavity and the communicating pore, and at least a portion of the ventilation flow channel is arranged along a second direction, which intersects with the first direction.

### CROSS REFERENCE TO RELATED APPLICATION

This application is a continuation of International Application No. PCT/CN2024/128305, filed on Oct. 29, 2024, which claims priority to Chinese Patent Application No. 202411075506.9, titled “LIQUID STORAGE ASSEMBLY AND ORAL CLEANER” and filed to the China National Intellectual Property Administration on Aug. 5, 2024, the entire contents of which are incorporated herein by reference.

### TECHNICAL FIELD

Embodiments of the present disclosure relate to the field of oral cleaner technology, and more particularly, to a liquid storage assembly and an oral cleaner.

### BACKGROUND

As people pay more attention to oral care, oral cleaners have gradually become common household oral care tools. The oral cleaners with teeth rinsing functions such as oral irrigators and integrated rinsing cleaners can use water pumps to pump out high-speed water columns with a certain pressure, and can clean teeth and slits between teeth by means of impact force of the high-speed water columns.

A related oral cleaner with the teeth rinsing functions may include a casing, a water pump, a water tank, and a teeth rinsing head. The teeth rinsing head may be arranged at one end of the casing, and the teeth rinsing head has a teeth rinsing channel for liquid flow. The water tank and the water pump are arranged in an inner cavity of the casing, and the water pump can pump out a liquid in the water tank through the teeth rinsing channel. To prevent failure of pumping water due to formation of vacuum in the inner cavity of the water tank, the related oral cleaner is provided with a ventilation flow channel that communicates the inner cavity of the water tank with outside to balance internal and external gas pressure of the water tank.

However, the above ventilation flow channel is longer, and thus is not conducive to gas flow.

### SUMMARY

One aspect of the embodiments of the present disclosure provides a liquid storage assembly for a device having a pump mechanism. The liquid storage assembly includes: a casing having a first shell wall, where the first shell wall is provided with a communicating pore penetrating through the first shell wall along a first direction, and at least a portion of an inner surface of the first shell wall is configured to limit a liquid storage cavity; and a limiting member positioned on an inner side of the first shell wall and configured to limit a ventilation flow channel. The ventilation flow channel is communicated with the liquid storage cavity and the communicating pore, and at least a portion of the ventilation flow channel is arranged along a second direction, which intersects with the first direction.

Alternatively, the limiting member includes a first part and a second part connected in sequence, where the first part covers the communicating pore, and a space interval between the second part and the inner surface of the first shell wall forms the ventilation flow channel.

Alternatively, the first part and the inner surface of the first shell wall limit and form a gas storage cavity communicated with the communicating pore and the ventilation flow channel.

Alternatively, the space interval between the second part and the inner surface of the first shell wall ranges between 0.04 mm and 0.2 mm along a radial direction of a gas flow direction.

Alternatively, the first shell wall is provided with a first mating section, and the second part is provided with a second mating section, where the second mating section is in concave-convex mate with the first mating section, and at least a portion of the ventilation flow channel is limited between the second mating section and the first mating section.

Alternatively, the liquid storage assembly also includes a sealing element, the limiting member includes a third part connected to one end of the first part away from the second part, and the third part the inner surface of the first shell wall are sealed by the sealing element.

Alternatively, the space interval between the second part and the inner surface of the first shell wall is communicated with a top of the liquid storage cavity.

Alternatively, the limiting member also includes a fourth part connected to the first part or the second part, where the fourth part is arranged along a direction intersecting the inner surface of the first shell wall, and the fourth part limits the liquid storage cavity together with at least a portion of the inner surface of the first shell wall.

The gas storage cavity and at least a portion of the liquid storage cavity are arranged side by side, or the gas storage cavity is positioned on one side of the liquid storage cavity in the second direction.

Alternatively, the device having the pump mechanism includes a built-in component, the fourth part is provided with a mounting recess having an opening on a side facing away from the liquid storage cavity, and the first part is provided with a groove having a groove opening facing towards the communicating pore. The limiting member is configured to deform by mating with the built-in component when the built-in component is embedded in the mounting recess, such that a surface of the first part props up against the inner surface of the first shell wall, and an inner cavity of the groove constitutes at least a portion of the gas storage cavity.

Alternatively, the built-in component is connected to the mounting recess by means of snap fit.

Alternatively, the first shell wall is a side wall of the casing, an outer surface of the first shell wall is provided with a plurality of protrusions, and at least a portion of the plurality of protrusions surround an outer side of the communicating pore.

Alternatively, the liquid storage assembly also includes a gas-permeable membrane for gas ventilation and liquid blocking, where the gas-permeable membrane covers the communicating pore.

One aspect of the embodiments of the present disclosure provides an oral cleaner, which includes a spray head, a pump mechanism, and the liquid storage assembly as described above. The spray head is arranged at one end of the casing of the liquid storage assembly, and the spray head has a liquid flow channel communicated with outside. The pump mechanism is arranged in the inner cavity of the casing, and the pump mechanism can pump a liquid in the liquid storage cavity into the liquid flow channel.

Alternatively, the oral cleaner also includes a motor and a connector. The motor and the pump mechanism are arranged at intervals along the second direction, where the motor has an output shaft connected to the spray head and configured to drive the spray head to move, and the output shaft of the motor has a first flow channel communicated with the liquid flow channel.

The connector has a second flow channel communicating a liquid outlet end of the pump mechanism with the first flow channel.

The spray head has bristles.

### BRIEF DESCRIPTION OF THE DRAWINGS

To describe the technical solutions in the embodiments of the present disclosure more clearly, the accompanying drawings required for describing the embodiments will be briefly introduced below. Apparently, the accompanying drawings in the following description are merely some embodiments of the present disclosure. To those of ordinary skills in the art, other accompanying drawings may also be derived from these accompanying drawings without creative efforts.

FIG. 1 is a schematic diagram of an oral cleaner according to an embodiment of the present disclosure;

FIG. 2 is a longitudinal sectional view of the oral cleaner shown in FIG. 1;

FIG. 3 is a schematic partial diagram of a liquid storage assembly shown in FIG. 2;

FIG. 4 is a schematic partial diagram of a communicating pore shown in FIG. 3;

FIG. 5 is a front view of a limiting member shown in FIG. 2; and

FIG. 6 is a schematic partial diagram of another liquid storage assembly according to an embodiment of the present disclosure.

### REFERENCE NUMERALS IN THE ACCOMPANYING DRAWINGS

liquid storage assembly 1000;
casing 100; first shell wall 110; inner surface 111; outer surface 112;
communicating pore 120; first mating section 130;
liquid storage cavity 200;
limiting member 300; first part 310; second part 320; third part 330; fourth part 340; second mating section 350; mounting recess 360; groove 370;
ventilation flow channel 400;
gas storage cavity 500;
sealing element 600;
protrusion 700;
gas-permeable membrane 800;
cleaning accessory 2000; brush body 2100; bristles 2200; liquid inlet 2300; liquid outlet 2400; cavity 2500;
motor 3000; motor body 3100; output shaft 3200;
pump mechanism 4000;
connector 5000; second flow channel 5100; and
built-in component 6000.

### DETAILED DESCRIPTION

Objectives of embodiments of the present disclosure are to provide a liquid storage assembly and an oral cleaner, which can solve the problem that a longer ventilation flow channel is disadvantageous to gas flow.

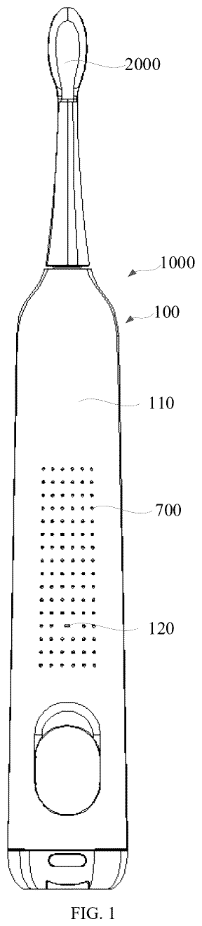

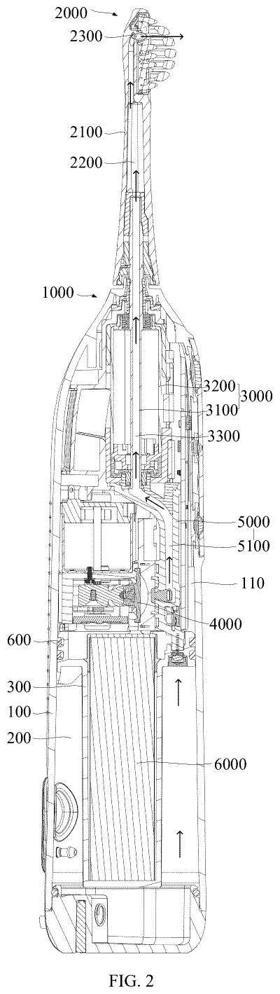

FIG. 1 is a schematic diagram of an oral cleaner according to an embodiment of the present disclosure, and FIG. 2 is a longitudinal sectional view of the oral cleaner shown in FIG. 1. With reference to FIG. 1 and FIG. 2, the oral cleaner provided in the embodiments of the present disclosure may include an oral cleaning apparatus 1000 and a cleaning accessory 2000, where the cleaning accessory 2000 may be a device capable of cleaning an oral cavity, such as a spray head, or an integrated rinsing head. The integrated rinsing head refers to a device that has both a brush head and the spray head. For example, as shown in FIG. 2, the cleaning accessory 2000 may include a brush body 2100 and bristles 2200 connected to one end of the brush body 2100. The brush body 2100 may have a liquid inlet 2300, a liquid outlet 2400, and a cavity 2500 communicated between the liquid inlet 2300 and the liquid outlet 2400. The bristles 2200 may surround an outer periphery of the liquid outlet 2400. The oral cleaning apparatus 1000 may be assembled at the liquid inlet 2300. After the user enables the teeth brushing function, the oral cleaning apparatus 1000 can drive the brush body 2100 to move, which in turn drives the bristles 2200 to move. After the user enables the teeth rinsing function, the oral cleaning apparatus 1000 can allow the liquid to flow into the cavity 2500 through the liquid inlet 2300 and to flow out through the liquid outlet 2400.

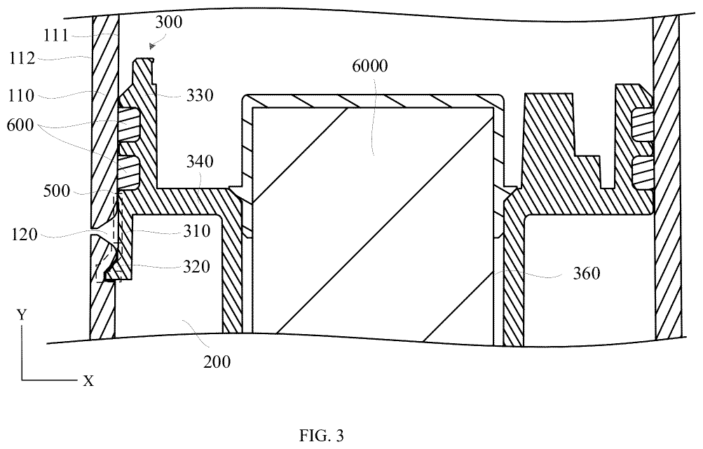

With continued reference to FIG. 2, the oral cleaning apparatus 1000 may include a liquid storage assembly 1000 and a power assembly. The liquid storage assembly 1000 may include a casing 100. To make it easier for the user to grip, the casing 100 may be shaped like an elongated cylinder. A cross section of the casing 100 may be circular or non-circular (such as D-shaped, oval, or polygonal). FIG. 3 is a schematic partial diagram of the liquid storage assembly shown in FIG. 2. Referring to FIG. 2 and FIG. 3, the casing 100 may have a first shell wall 110, where a thickness direction of the first shell wall 110 is a first direction, and the first shell wall 110 may have an outer surface 112 and an inner surface 111 arranged opposite to each other in the first direction. At least a portion of the inner surface 111 of the first shell wall 110 may limit the liquid storage cavity 200. That is, at least a portion of the inner surface 111 of the first shell wall 110 may serve as an inner cavity wall of the liquid storage cavity 200.

With continued reference to FIG. 2, the power assembly may be arranged in the inner cavity of the casing 100, and can achieve the teeth rinsing function or the integrated rinsing function of the oral cleaner.

For example, when the cleaning accessory 2000 is the spray head, the power assembly may be the pump mechanism 4000, and the liquid outlet end of the pump mechanism 4000 may be directly communicated with the liquid inlet of the cleaning accessory 2000. When rinsing teeth, the pump mechanism 4000 may guide the liquid in the liquid storage cavity 200 to be pumped into the inner cavity 2500 of the cleaning accessory 2000 and sprayed out of the liquid outlet 2400 of the cleaning accessory 2000.

For another example, when the cleaning accessory 2000 is the integrated rinsing head, referring to FIG. 2, the power assembly may include a motor 3000 and the pump mechanism 4000. To maintain the elongated shape of the casing 100, the motor 3000 and the pump mechanism 4000 may be arranged in sequence along a length direction of the casing 100. The motor 3000 may be closer to the top of the casing 100 than the pump mechanism 4000, such that the output shaft 3200 of the motor 3000 runs through the top of the casing 100 and connects the cleaning accessory 2000 to drive the cleaning accessory 2000 to move, thereby achieving the teeth brushing function. The motor 3000 may be a rotating motor capable of rotating the cleaning accessory 2000, or the motor 3000 may be a vibration motor (such as an acoustic motor 200) capable of making the cleaning accessory 2000 swing at a higher frequency. The motor 3000 may include a motor body 3100 and the output shaft 3200. An axis of the output shaft 3200 and a central axis of the casing 100 may coincide with each other or may be arranged at parallel intervals. The output shaft 3200 may pass through the motor body 3100 along its axial direction. In addition, the output shaft 3200 may have, along its axial direction, a first end and a second end that are arranged opposite to each other. The first end of the output shaft 3200 may run through the motor body 3100 and connect the cleaning accessory 2000 to drive the cleaning accessory 2000 to move. In addition, the output shaft 3200 may have, along its axial direction, a first flow channel 3300 that penetrates through the output shaft 3200. The second end of the output shaft 3200 may run through the motor body 3100 and connect the liquid outlet end of the pump mechanism 4000 through the connector 5000, such that the second flow channel 5100 of the connector 5000 communicates the first flow channel 3300 of the output shaft 3200 with the liquid outlet end of the pump mechanism 4000. In this way, during teeth rinsing, the pump mechanism 4000 may guide the liquid in the liquid storage cavity 200 (arrows in FIG. 2 show flow paths of the liquid) to flow through the second flow channel 5100 of the connector 5000, the first flow channel 3300 of the output shaft 3200 of the motor 3000, the inner cavity 2500 of the cleaning accessory 2000, and to spray out of the liquid outlet 2400 of the cleaning accessory 2000.

Referring to FIG. 3, as mentioned above, at least a portion of the inner surface 111 of the first shell wall 110 limits the liquid storage cavity 200. To ensure that the pump mechanism 4000 can pump the liquid in the liquid storage cavity 200, the first shell wall 110 may be provided with a communicating pore 120 that communicates the outside with the liquid storage cavity 200. To prevent the liquid from flowing out of the communicating pore 120 when the user places the oral cleaner horizontally or shakes the oral cleaner, the liquid storage assembly 1000 provided in the embodiments of the present disclosure may also include a limiting member 300, and a ventilation flow channel 400 for gas ventilation and liquid blocking is formed by means of the limiting member 300 and the first shell wall 110.

Specifically, the communicating pore 120 may penetrate through the first shell wall 110 along the first direction. That is, a depth direction of the communicating pore 120 is the first direction, and one end of the communicating pore 120 in the first direction extends to the outer surface 112 of the first shell wall 110, and other end of the communicating pore 120 in the first direction extends to the inner surface 111 of the first shell wall 110. In this way, the first shell wall 110 not only limits the liquid storage cavity 200, but also has the communicating pore 120 to reduce the distance between the communicating pore 120 and the liquid storage cavity 200. In this way, the flow paths of gas are shortened, which may facilitate pumping of the pump mechanism 4000.

In addition, the limiting member 300 may be arranged on the inner side of the first shell wall 110 to limit the ventilation flow channel 400. The inner side of the first shell wall 110 refers to one side of the inner surface 111 of the first shell wall 110, that is, one side of the first shell wall 110 facing toward the inner cavity of the casing 100. In addition, the ventilation flow channel 400 communicates the liquid storage cavity 200 with the communicating pore 120, and at least a portion of the ventilation flow channel 400 is arranged along the second direction. The second direction intersects with the first direction.

It is to be understood that if the communicating pore 120 is directly communicated with the liquid storage cavity 200, the liquid in the liquid storage cavity 200 is easily splashed out of the pore when the user shakes the device along the axial direction (the first direction) of the communicating pore 120. To avoid this situation, in the embodiments of the present disclosure, the ventilation flow channel 400 is arranged between the communicating pore 120 and the liquid storage cavity 200, and at least a portion of the ventilation flow channel 400 is arranged along the second direction, which intersects with the axial direction (the first direction) of the communicating pore 120. In this way, the liquid can be prevented from splashing out of the ventilation hole when the user shakes the device along the axial direction of the communicating pore 120.

Alternatively, there may be one or more communicating pores 120. When there are a plurality of communicating pores 120, the plurality of communicating pores 120 may be arranged around the first shell wall 110. The shape of the communicating pore 120 may be various. For example, the cross-sectional shape of the communicating pore 120 may be circular, waist-shaped, rectangular, and so on. The shape of a longitudinal section of the communicating pore 120 may be rectangular or conical, etc.

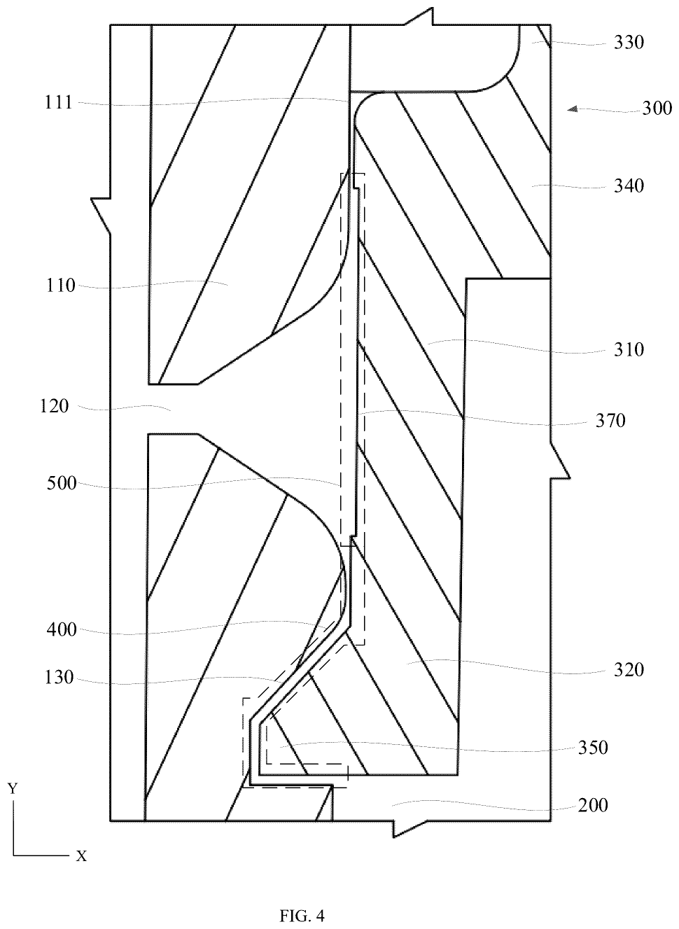

FIG. 4 is a schematic partial diagram of the communicating pore 120 shown in FIG. 3. Referring to FIG. 3 and FIG. 4, alternatively, the limiting member 300 may include a first part 310 and a second part 320 connected in sequence. The first part 310 may cover the communicating pore 120, and a space interval between the second part 320 and the inner surface 111 of the first shell wall 110 forms the ventilation flow channel 400. In this way, the ventilation flow channel 400 formed by means of the space interval has a smaller cross-sectional area and a longer length, and is easy to process.

Further, along a radial direction of a gas flow direction, the space interval between the second part 320 and the inner surface 111 of the first shell wall 110 ranges between 0.04 mm and 0.2 mm, to balance ventilation effects and liquid blocking effects. The radial direction along the gas flow direction refers to the distance between the second part 320 and the inner surface 111 of the first shell wall 110 (perpendicular to the gas flow direction).

Referring to FIG. 3 and FIG. 4, further, the first shell wall 110 may be provided with a first mating section 130, and the second part 320 is provided with a second mating section 350, where the second mating section 350 is in concave-convex mate with the first mating section 130, and at least a portion of the ventilation flow channel 400 is limited between the second mating section 350 and the first mating section 130. For example, in FIG. 3 and FIG. 4, the first mating section 130 is a groove body, and the second mating section 350 is a bump embedded in the groove body. For another example, the first mating section 130 is a bump, and the second mating section 350 is a groove body that accommodates the bump. Still further, the first mating section 130 may be connected to the second mating section 350 by means of snap fit, to achieve assembly between the limiting member 300 and the first shell wall 110 when the ventilation flow channel 400 is formed.

Alternatively, the space interval between the second part 320 and the inner surface 111 of the first shell wall 110 may be communicated with a top, a middle or the like of the liquid storage cavity 200. FIG. 3 and FIG. 4 are shown by taking an example where the space interval is communicated with the top of the liquid storage cavity 200.

Alternatively, the liquid storage assembly 1000 provided in the embodiments of the present disclosure may also include a gas-permeable membrane 800 for gas ventilation and liquid blocking, where the gas-permeable membrane 800 may cover the communicating pore 120, to further enhance the liquid blocking effects. The gas-permeable membrane 800 may be arranged on one side of the ventilation hole along the first direction, or the gas-permeable membrane 800 may be embedded in the ventilation hole.

There are several ways as below to arrange the first part 310. For example, the first part 310 may be slightly larger than the communicating pore 120, and there is no airflow channel between the first part 310 and the first shell wall 110. Gas can directly enter, through the ventilation hole, the ventilation flow channel 400 formed by the second part 320 and the first shell wall 110.

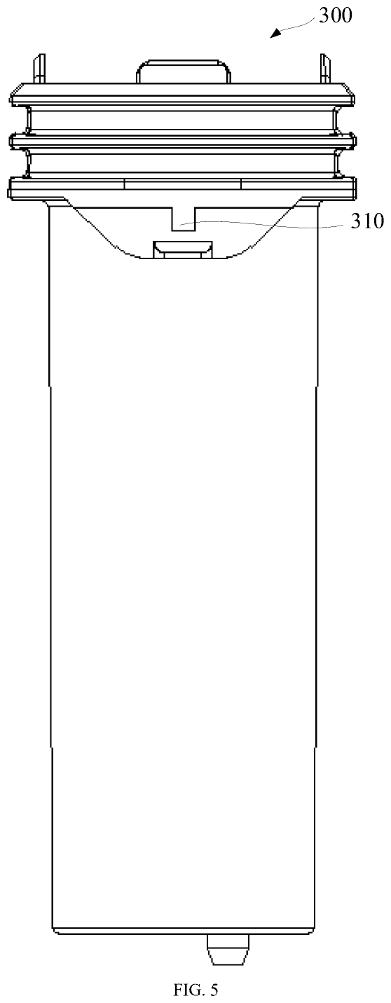

For another example, referring to FIGS. 3 to 5, the first part 310 and the inner surface 111 of the first shell wall 110 may limit and form a gas storage cavity 500 communicated with the communicating pore 120 and the ventilation flow channel 400. In this way, flow of the gas is facilitated. Further, the first part 310 may be provided with a groove 370, which may have a groove opening facing towards the communicating pore 120, and the inner cavity of the groove 370 constitutes at least a portion of the gas storage cavity 500. In this way, the gas storage cavity 500 is formed by means of the inner cavity of the groove 370, to improve the ventilation effects.

Alternatively, the liquid storage assembly 1000 provided in the embodiments of the present disclosure may also include a sealing element 600. The limiting member 300 may also include a third part 330, where the third part 330 may be connected to one end of the first part 310 away from the second part 320, and the third part 330 the inner surface 111 of the first shell wall 110 are sealed by the sealing element 600. In this way, the liquid or gas is prevented from entering an upper side of the liquid storage cavity 200, thereby avoiding contaminating the power assembly arranged above the liquid storage cavity 200. In addition, the sealing element 600 may be made of elastic sealing materials such as rubber.

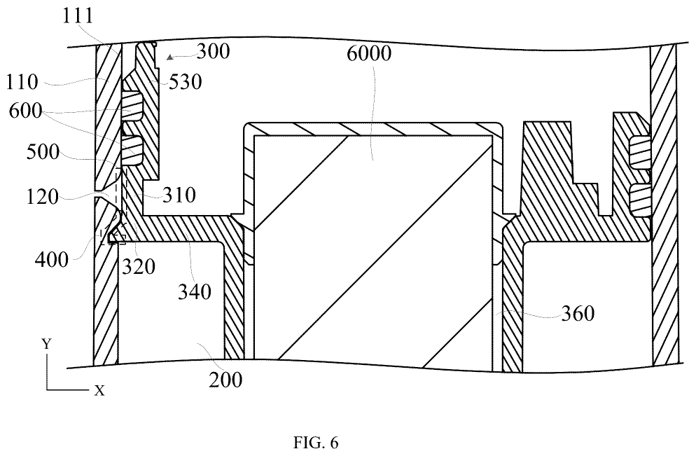

Further, the limiting member 300 may also include a fourth part 340, where the fourth part 340 may be connected to the first part 310 or the second part 320, and the fourth part 340 may be arranged along a direction intersecting the inner surface 111 of the first shell wall 110. Moreover, the fourth part 340 may limit the liquid storage cavity 200 together with at least a portion of the inner surface 111 of the first shell wall 110. The gas storage cavity 500 and at least a portion of the liquid storage cavity 200 may be arranged side by side as shown in FIG. 3 and FIG. 4, or the gas storage cavity 500 may be positioned on one side of the liquid storage cavity 200 in the second direction, as shown in FIG. 6.

Alternatively, the oral cleaner may also include a built-in component 6000 (such as a battery). The fourth part 340 may be provided with a mounting recess 360 having an opening on a side facing away from the liquid storage cavity 200. The first part 310 is provided with a groove 370 having a groove opening facing towards the communicating pore 120. The limiting member 300 is configured to deform by mating with the built-in component 6000 when the built-in component 6000 is embedded in the mounting recess 360, such that a surface of the first part 310 props up against the inner surface 111 of the first shell wall 110, and an inner cavity of the groove 370 constitutes at least a portion of the gas storage cavity 500. In this way, the gas storage cavity 500 is formed by arranging the groove 370 to facilitate the flow of the gas. In addition, due to external expansion and deformation occurred in the limiting member 300 after the built-in component 6000 is placed in the mounting recess 360, the surface of the limiting member 300 may press against the inner surface 111 of the first shell wall 110, to form a unified width of the gas storage cavity 500 (i.e. a depth of the groove 370) and a width of the ventilation flow channel 400, to improve yield rate.

Further, the built-in component 6000 may be connected to the mounting recess 360 by means of snap fit, to facilitate disassembly and assembly of the built-in component 6000.

Referring to FIG. 1, alternatively, the first shell wall 110 may be a side wall of the casing 100, the outer surface 112 of the first shell wall 110 is provided with a plurality of protrusions 700, and at least a portion of the plurality of protrusions 700 surround an outer side of the communicating pore 120. In this way, by providing the plurality of protrusions 700, the ventilation hole is not easily blocked when the user holds the casing 100, which is conducive to air circulation.

In summary, in the liquid storage assembly and the oral cleaner provided in the embodiments of the present disclosure, the first shell wall can limit the liquid storage cavity, and the communicating pore is also arranged on the first shell wall to reduce a distance between the communicating pore and the liquid storage cavity. In addition, if the communicating pore is directly communicated with the liquid storage cavity, the liquid in the liquid storage cavity may easily splash out through the pore when a user shakes the device along an axial direction (the first direction) of the communicating pore. To avoid this situation, in the embodiments of the present disclosure, the ventilation flow channel is arranged between the communicating pore and the liquid storage cavity, and at least a portion of the ventilation flow channel is arranged along a second direction, which intersects with the axial direction (the first direction) of the communicating pore. In this way, the liquid can be prevented from splashing out of the ventilation hole when the user shakes the device along the axial direction of the communicating pore.

What is claimed is:

1. A liquid storage assembly used for a device having a pump mechanism, wherein the liquid storage assembly comprises:
a casing having a first shell wall, the first shell wall being provided with a communicating pore penetrating through the first shell wall along a first direction, and at least a portion of an inner surface of the first shell wall being configured to limit a liquid storage cavity; and
a limiting member positioned on an inner side of the first shell wall and configured to limit a ventilation flow channel;
the ventilation flow channel being communicated with the liquid storage cavity and the communicating pore, and at least a portion of the ventilation flow channel being arranged along a second direction intersecting with the first direction.

2. The liquid storage assembly according to claim 1, wherein the limiting member comprises a first part and a second part connected in sequence;
the first part covers the communicating pore;
a space interval between the second part and the inner surface of the first shell wall forms the ventilation flow channel.

3. The liquid storage assembly according to claim 2, wherein the first part and the inner surface of the first shell wall limit and form a gas storage cavity communicated with the communicating pore and the ventilation flow channel.

4. The liquid storage assembly according to claim 2, wherein the space interval between the second part and the inner surface of the first shell wall ranges between 0.04 mm and 0.2 mm along a radial direction of a gas flow direction.

5. The liquid storage assembly according to claim 2, wherein the first shell wall is provided with a first mating section, the second part is provided with a second mating section, the second mating section is in concave-convex mate with the first mating section, and at least a portion of the ventilation flow channel is limited between the second mating section and the first mating section.

6. The liquid storage assembly according to claim 2, further comprising a sealing element; wherein
the limiting member comprises a third part connected to one end of the first part away from the second part, and the third part the inner surface of the first shell wall are sealed by the sealing element.

7. The liquid storage assembly according to claim 2, wherein the space interval between the second part and the inner surface of the first shell wall is communicated with a top of the liquid storage cavity.

8. The liquid storage assembly according to claim 7, wherein the limiting member further comprises a fourth part connected to the first part or the second part, the fourth part is arranged along a direction intersecting the inner surface of the first shell wall, and the fourth part limits the liquid storage cavity together with at least a portion of the inner surface of the first shell wall; and
the gas storage cavity and at least a portion of the liquid storage cavity are arranged side by side, or the gas storage cavity is positioned on one side of the liquid storage cavity in the second direction.

9. The liquid storage assembly according to claim 8, wherein the device having the pump mechanism comprises a built-in component;
the fourth part is provided with a mounting recess having an opening on a side facing away from the liquid storage cavity;
the first part is provided with a groove having a groove opening facing towards the communicating pore; and
the limiting member is configured to deform by mating with the built-in component when the built-in component is embedded in the mounting recess, such that a surface of the first part props up against the inner surface of the first shell wall, and an inner cavity of the groove constitutes at least a portion of the gas storage cavity.

10. The liquid storage assembly according to claim 9, wherein the built-in component is connected to the mounting recess by means of snap fit.

11. The liquid storage assembly according to claim 1, wherein the first shell wall is a side wall of the casing, an outer surface of the first shell wall is provided with a plurality of protrusions, and at least a portion of the plurality of protrusions surround an outer side of the communicating pore.

12. The liquid storage assembly according to claim 1, further comprising a gas-permeable membrane for gas ventilation and liquid blocking, wherein the gas-permeable membrane covers the communicating pore.

13. An oral cleaner comprising a spray head, a pump mechanism, and the liquid storage assembly as claimed in claim 1, wherein the spray head is arranged at one end of the casing of the liquid storage assembly, and the spray head has a liquid flow channel communicated with outside; the pump mechanism is arranged in the inner cavity of the casing, and the pump mechanism is configured to pump a liquid in the liquid storage cavity into the liquid flow channel.

14. The oral cleaner according to claim 13 further comprising a motor and a connector, wherein the motor and the pump mechanism are arranged at intervals along the second direction, the motor has an output shaft connected to the spray head and configured to drive the spray head to move, and the output shaft of the motor has a first flow channel communicated with the liquid flow channel;
the connector has a second flow channel communicating a liquid outlet end of the pump mechanism with the first flow channel; and
the spray head has bristles.
